(19) United States
(12) Patent Application Publication
(10) Pub. No.: US 2010/0028504 A1
(43) Pub. Date: Feb. 4, 2010

(54) Method and apparatus for nature decorating fruit as such fruit is being ripened on the tree

(76) Inventor: James K. Perry, Eagle Bridge, NY (US)

Correspondence Address: JAMES RAY & ASSOCIATES, 2640 PITCAIRN ROAD, MONROEVILLE, PA, 15146, US

(21) Appl. No.: 12/221,272

(22) Filed: Aug. 1, 2008

(51) Int. Cl. A23L 1/27; A01G 17/00; A01G 13/00

(52) U.S. Cl. 426/262; 47/1.5; 47/24.1; 47/32.3

(57) ABSTRACT

An apparatus for producing a pre-selected design on an outer surface of a pre-selected piece of fruit by a natural ripening process. The apparatus includes at least one sticker having a predetermined design. The at least one sticker is engageable with and attachable to such outer surface of such pre-selected fruit prior to such pre-selected fruit ripening. The at least one sticker prevents an area covered thereby from changing color as such pre-selected fruit ripens and a remaining outer surface thereof does change color.

### FIELD OF THE INVENTION

The present invention relates, in general, to tree ripened fruit and, more particularly, this invention relates to a method of and an apparatus for decorating fruit while such fruit is being ripened on the tree.

### BACKGROUND OF THE INVENTION

Prior to the conception and development of the present invention, as is generally well known in the prior art, fruit ripens naturally by the sun. Such fruit normally takes on a generally uniform color and texture over the entire outer surface thereof.

Attempts to decorate fruit have been in existence for some time, however, none of the prior art attempts of which applicant is aware of have been commercially successful.

These attempts are exemplified by U.S. Pat. No. 6,855,224 “Pressure Sensitive Composite For Decorating Surfaces Of Fruits And Vegetables And Use Thereof”; U.S. Pat. No. 4,919,954 “Compositions And Method Of Decorating Firm-Rinded Fruit”; U.S. Pat. No. 4,698,226 “Apple Labeling Process”; and U.S.P. Pub. No. 2005/0186313 “Method For Decorating A Fruit Surface”.

Some of these prior art type decorating attempts use certain chemicals and dyes to decorate the outer skin surface of the fruit. None of these prior art teachings utilized nature to decorate the fruit.

### SUMMARY OF THE INVENTION

The present invention provides, in a first aspect thereof, an apparatus for producing a pre-selected design on an outer surface of a pre-selected piece of fruit by a natural ripening process. The apparatus comprising at least one sticker having a predetermined design. The at least one sticker is engageable with and attachable to such outer surface of such pre-selected fruit prior to such pre-selected fruit ripening. Additionally, the at least one sticker prevents an area covered thereby from changing color as such pre-selected fruit ripens and allowing a remaining outer surface of such pre-selected fruit to change color.

According to a second aspect, the present invention provides a method of producing a pre-selected design on an outer surface of a pre-selected piece of fruit by a natural ripening process. The method includes the steps of selecting at least one piece of fruit to receive the design thereon. Further, the method includes selecting a particular design to be placed on the outer surface of the piece of fruit selected and providing at least one sticker having the design selected. Thereafter, adhering the at least one sticker provided to the outer surface of the piece of fruit selected prior to the piece of fruit ripening and thereby preventing an area covered by the at least one sticker from changing color as the piece of fruit selected ripens and a remaining outer surface thereof changes color.

### OBJECTS OF THE INVENTION

It is, therefore, one of the primary objects of the present invention to provide a method of and an apparatus for producing a pre-selected design on an outer surface of a pre-selected piece of fruit by a natural ripening process.

Another object of the present invention is to provide an apparatus for producing a pre-selected design on an outer surface of a pre-selected piece of fruit by a natural ripening process which is easy to use.

Still another object of the present invention is to provide an apparatus for producing a pre-selected design on an outer surface of a pre-selected piece of fruit by a natural ripening process which is inexpensive to make.

Yet another object of the present invention is to provide an apparatus for producing a pre-selected design on an outer surface of a pre-selected piece of fruit by a natural ripening process which does not require dyes and/or other chemicals to make the design.

An additional object of the present invention is to provide an apparatus for producing a pre-selected design on an outer surface of a pre-selected piece of fruit by a natural ripening process which can be used on a variety of different fruits.

A still further object of the present invention is to provide a method of and an apparatus for producing a pre-selected design on an outer surface of a pre-selected piece of fruit by a natural ripening process which can be tailored to special occasions and for special persons.

In addition to the various objects and advantages of the present invention which have been described with some degree of specificity above, it should be obvious that there are additional objects and advantages of the present invention which will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a side elevation view of an apple having a presently preferred design formed on an outer surface thereof;

FIG. 2 is a plan view of a presently preferred apparatus for decorating the outer surface of the apple illustrated in FIG. 1.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that for the sake of brevity certain well known shapes, animals, and fruits have not been illustrated in the drawings.

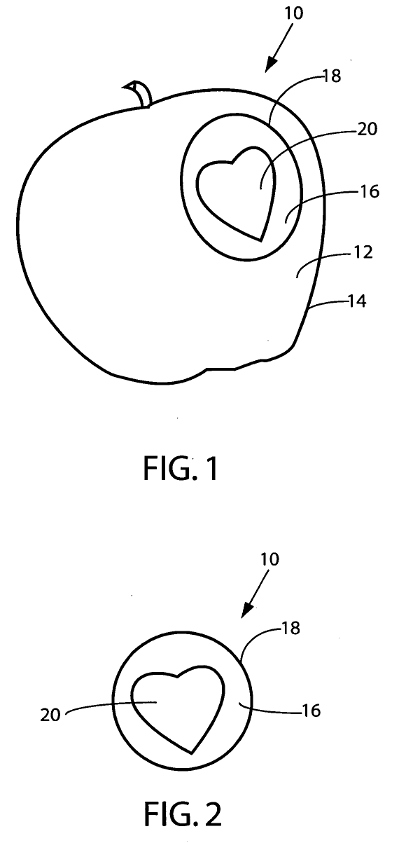

Reference is now made, more particularly, to FIG. 1. Illustrated therein is an apparatus, generally designated 10, for producing a pre-selected design on an outer surface 12 of a pre-selected piece of fruit 14 by a natural ripening process. The apparatus 10 includes at least one sticker 16 having a predetermined design engageable with and attachable to such outer surface 12 of the pre-selected fruit 14 prior to the pre-selected fruit 14 becoming ripe. The at least one sticker 16 preventing an area covered thereby from changing color as the pre-selected fruit 14 ripens and a remaining outer surface thereof changes color.

In the presently preferred embodiment of the apparatus 10 the predetermined design includes each of an outer perimeter design 18 and at least one other predetermined design 20 disposed within the outer perimeter design 18 of the at least one sticker 16. The outer perimeter design 18 is selected from the group consisting of generally circular, oval, rectangular, hexagonal and octagonal.

It is presently preferred that the at least one other predetermined design 20 disposed within the outer perimeter of such at least one sticker 16 is selected from the group consisting of at least one heart, auto, boat, ball and animal.

When such at least one other predetermined design 20 disposed within such outer perimeter of such at least one sticker 16 is an animal it is preferred that the animal is a pet animal selected from the group consisting of a dog, cat, horse, hamster and rabbit.

According to the invention, the pre-selected piece of fruit 14 is selected from the group consisting of apples, oranges, limes, lemons and tomatoes. Preferably, the piece of fruit is an apple.

The present invention further provides method of producing a pre-selected design on an outer surface of a pre-selected piece of fruit 14 by a natural ripening process. The method includes selecting a piece of fruit 14 to receive such design as well as selecting a design to be placed on the outer surface 12 of the piece of fruit 14 selected.

The method also requires providing at least one sticker 16 having the design selected and thereafter adhering the at least one sticker 16 to the outer surface 12 of the piece of fruit 14 selected prior to the piece of fruit selected ripening and thereby preventing a surface area covered by the at least one sticker 16 from changing color as the piece of fruit 16 ripens and a remaining outer surface thereof changes color.

The final essential step requires removing the at least one sticker from the piece of fruit after such piece of fruit has ripened.

The piece of fruit 14 is, preferably, selected from the group consisting of apples, oranges, limes, lemons and tomatoes with an apple being the most presently preferred.

It is also within the scope of the present invention for the design to be selected being based on one of a special occasion and a particular person. It is anticipated that a heart will be the one most preferred.

Likewise, the method includes having the predetermined design selected to include each of an outer perimeter design and at least one other predetermined design disposed within an outer perimeter of the at least one sticker 16.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. An apparatus for producing a pre-selected design on an outer surface of a pre-selected piece of fruit by a natural ripening process, said apparatus comprising at least one sticker having a predetermined design engageable with and attachable to such outer surface of said pre-selected fruit prior to said pre-selected fruit ripening, said at least one sticker preventing an area covered thereby from changing color as said pre-selected fruit ripens and a remaining outer surface thereof changes color.

2. An apparatus, according to claim 1, wherein said predetermined design includes each of an outer perimeter design and at least one other predetermined design disposed within said outer perimeter of said at least one sticker.

3. An apparatus, according to claim 2, wherein said outer perimeter design is selected from the group consisting of generally circular, oval, rectangular, hexagonal and octagonal.

4. An apparatus, according to claim 2, wherein said at least one other predetermined design disposed within said outer perimeter of said at least one sticker is selected from the group consisting of at least one heart, auto, boat, ball and animal.

5. An apparatus, according to claim 4, wherein said at least one other predetermined design disposed within said outer perimeter of said at least one sticker is a pet animal selected from the group consisting of a dog, cat, horse, hamster and rabbit.

6. An apparatus, according to claim 1, wherein said pre-selected piece of fruit is selected from the group consisting of apples, oranges, limes, lemons and tomatoes.

7. An apparatus, according to claim 6, wherein said pre-selected piece of fruit is an apple.

8. A method of producing a pre-selected design on an outer surface of a pre-selected piece of fruit by a natural ripening process, said method comprising the steps of:
(a) selecting a piece of fruit to receive said design;
(b) selecting a design to be placed on said outer surface of said piece of fruit selected in step (a);
(c) providing at least one sticker having said design selected in step (b);
(d) adhering said at least one sticker provided in step (c) to said outer surface of said piece of fruit selected in step (a) prior to said piece of fruit selected in step (a) ripening and thereby preventing an area covered by said at least one sticker from changing color as said piece of fruit selected in step (a) ripens and a remaining outer surface thereof changes color; and
(e) removing said at least one sticker from said piece of fruit after said piece of fruit has ripened.

9. A method, according to claim 8, wherein said piece of fruit selected in step (a) is selected from the group consisting of apples, oranges, limes, lemons and tomatoes.

10. A method, according to claim 9, wherein said piece of fruit selected in step (a) is an apple.

11. A method, according to claim 8, wherein said design selected in step (b) is selected based on one of a special occasion and a particular person.

12. A method, according to claim 11, wherein said design selected in step (b) is a heart.

13. A method, according to claim 8, wherein said predetermined design selected in step (b) includes each of an outer perimeter design and at least one other predetermined design disposed within said outer perimeter of said at least one sticker.
